(19) United States
(12) Patent Application Publication
(10) Pub. No.: US 2006/0000852 A1
(43) Pub. Date: Jan. 5, 2006

(54) Portable dispenser for mixing and dispensing fluid mixtures

(76) Inventor: Joseph Manne, New York, NY (US)

Correspondence Address: LUCAS & MERCANTI, LLP, 475 PARK AVENUE SOUTH, 15TH FLOOR, NEW YORK, NY, 10016, US

(21) Appl. No.: 10/881,574

(22) Filed: Jun. 30, 2004

(51) Int. Cl. B67D 5/60

(52) U.S. Cl. 222/145.6

(57) ABSTRACT

The portable dispenser has individual supply chambers that communicate with a master chamber. Each of the supply chambers has a plunger to move fluid compositions from the supply chamber to the master chamber. The master chamber has a mixer to allow it to form a homogeneous mix of the individual compositions. An applicator is used to output the homogeneous mix.

### BACKGROUND OF THE INVENTION

1. Field of the Invention

The present invention relates to an improved dispenser and, more particularly, to a portable dispenser which forms a homogeneous mixture from individual fluid compositions. The portable dispenser of the present invention is especially applicable to personal care products such as toothpaste, shampoos and cosmetics.

2. Prior Art

Portable dispensers which form a mixture from individual fluid compositions are known, see U.S. Pat. No. 4,993,594. Portable dispensers for cosmetic compositions that form mixtures from individual cosmetic compositions are also known, see U.S. Pat. No. 6,655,551.

Consumers want the ability to formulate their own personal care products on-the-spot in thoroughly mixed various shades and amounts and thus, there is a need for a portable dispenser which can formulate personal care products on-the-spot in various shades.

### SUMMARY OF THE INVENTION

A portable, lightweight dispenser has now been discovered which allows for thorough on-the-spot mixing and dispensing of individual fluid compositions. The present invention allows two or more different individual, fluid compositions to be mixed to form a homogeneous fluid mixture which can then be dispensed and used immediately by the consumer. This dispenser is especially useful for personal care products and cosmetics.

Broadly, the present invention relates to a portable dispenser which comprises:
a) an elongated frame;
b) a master chamber affixed inside said frame, said master chamber having a mixing means for mixing individual fluids and forming a mixed fluid;
c) two or more supply chambers affixed outside said frame, each of said supply chambers being in fluid communication with said master chamber, each of said supply chambers having a dosage means for dosing individual fluid from said supply chamber to said master chamber; and
d) an exit port in a wall of said master chamber to allow mixed fluid to be dispensed from said master chamber.

Suitable fluid mixtures which can be formed using the present invention include fluid personal care products such as cosmetics, dentifrices, hand and body creams and lotions, soaps and shampoos, hand and hair conditioners, hair gels and styling preparations, suntan lotions and sun screens, deodorants, perfumes, shaving creams, and hair dyes or colors. Cosmetics which can be formulated with the present invention include lipstick, eye shadow, facial foundation, eyeliner, and fingernail polish. As pointed out, both the individual composition and the mixture formed from the compositions must be in a fluid form.

The term fluid as used in the written description and claims means a liquid or solid which can flow between the supply chamber and the master chamber and be mixed in the master chamber to form a homogeneous fluid mixture. The fluid must have viscosity to allow it to flow from the supply chamber into the master chamber. Thus, certain powders can be employed because they readily flow and can be mixed. Certain waxes or gels flow when subjected to pressure and can also be mixed in the master chamber.

The amount of each individual composition dosed into the master chamber can be determined by the user since each supply chamber has its own dosage means and the dosage means are controlled by the user. Each supply chamber has a dosage means associated therewith that allows the user to determine the amount of each composition to add to the master chamber. Each dosage means is separately and individually controlled and are not interconnected. Thus, the user must specifically add the amount of each individual composition each time they decide to formulate the mixture. This provides greater flexibility to the user. The individual can make their own determination of how much to add, or they can use a chart which shows the amount of each individual composition to add to the master chamber to form a predetermined mixture. Such a chart could be available in printed form or over the Internet.

The supply chambers are separately loaded with the individual compositions and the user is able to change the supply chambers either as they become empty or as they choose in order to use different individual compositions and increase their choices of the mixtures and the resulting shades produced by the mixtures.

By positioning the supply chambers outside the frame, the supply chambers can be easily changed or replenished as the need arises. This is one of the main improvements over the teaching of U.S. Pat. No. 6,655,551 where the supply chambers were positioned inside the frame. Supply chambers of the type used in the present Invention are removably attached to the outside of the frame.

Suitably, the frame is a shell.

The mixing means of the master chamber is suitably a motor positioned outside the master chamber and connected to an impeller or bar inside the master chamber by means of a shaft. The mixing means can also be nylon wires extending from a motor positioned outside the master chamber to inside the master chamber. The motor can be replaced with a mechanical hand crank, such as the one used in U.S. Pat. No. 6,655,551.

A tube is suitably used to provide fluid communication between the supply chambers and the master chamber. The outlet of the tube can be in a top, bottom or side wall of the master chamber. The inlet for the tube is preferably in the top wall of the supply chamber.

Each supply chamber suitable uses a plunger as a dosage means. The supply plunger can be pushed in linear manner in the same manner as a syringe or be threaded to screw inward. Using a threaded plunger allows for more control of the amount of individual fluid added to the master chamber. One embodiment of the threaded plunger is disclosed in U.S. Pat. No. 5,655,551, the disclosure of which is incorporated herein by reference. Preferably, the shaft of the plunger bears numerical indicia to allow for accurate dosing.

Preferably, the master chamber also has a plunger and the outlets for the tubes from the supply chamber to the master chamber are positioned at different heights or levels on the side wall of the master chamber. The head of the plunger can shut off the outlet of each supply chamber, thereby preventing back flow from one supply chamber to another supply chamber.

### BRIEF DESCRIPTION OF THE DRAWINGS

These and other aspects of the present invention may be more fully understood by reference to one or more of the following drawings wherein:

FIG. 1 is a side view of one embodiment of the dispenser of the present invention;

FIG. 2 is a side view of another embodiment of the dispenser of the present invention;

FIGS. 3A-3B is a top view of the dispenser having four (4) supply chambers;

FIGS. 4A-4B is a top view of the dispenser having six (6) supply chambers.

### DETAILED DESCRIPTION OF THE INVENTION

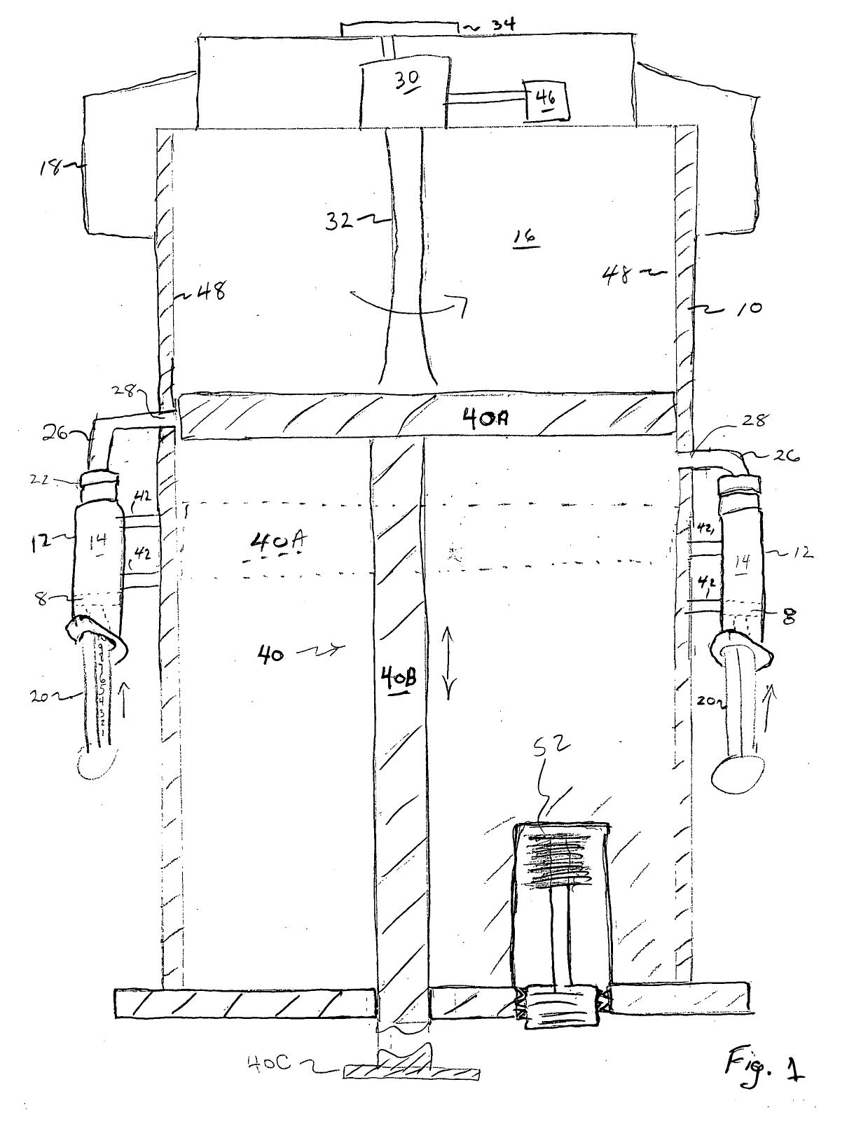

Turning to FIG. 1, the dispenser of the present invention has a hard elongated shell 10 with a movable master plunger 40 having a head 40A mounted therein and a shaft 40B which extends outside of shell 10 to handle 40C. Movable master plunger 40 slides up and down and is mounted in elongated shell 10 by means of frictional engagement. Shell 10 has holder brackets 42 mounted thereon which house supply chambers 12 on the outer perimeter. Inside each supply chamber 12 is a fluid composition 14. Each supply chamber 12 is equipped with supply plunger 20 at the bottom end and a dispensing tip 22 at the top end. Flexible tube 26 is attached to the top end of the dispensing tip 22. Tip 22 is removably attached to the top of supply chamber 12 and supply chamber 12 is removably affixed to brackets 42 so that supply chamber 12 can be removed from shell 10.

FIG. 1 shows outlet 28 is closed and there is no movement of fluid composition 14 from supply chamber 12 to master chamber 16. When plunger 40 is moved downward, phantom lines, outlet 28 at the top of flexible tube 26 is open into master chamber 16. As shown in FIG. 1, the top of each supply chamber 12 is in fluid communication with master chamber 16 via flexible tube 26 and outlet 28 at different heights in a side wall of master chamber 16. This allows head 40A to close off each individual outlet 28, one at a time and prevent back flow of the individual fluid.

Housed on top of master chamber 16 is a cap top 18. Cap top 18 is removed to provide access to the homogeneous fluid mixture in master chamber 16.

In order to mix the individual fluid compositions in master chamber 16, DC motor 30 is attached to nylon wire 32, which is housed in mixing chamber 16. DC motor 30 is housed in cap 18. Motor 30 rotates when switch button 34 is pressed, causing nylon wire 32 to rotate thereby mixing the fluid in mixing chamber 16. Power source 46, such as a battery, provides electricity to motor 30.

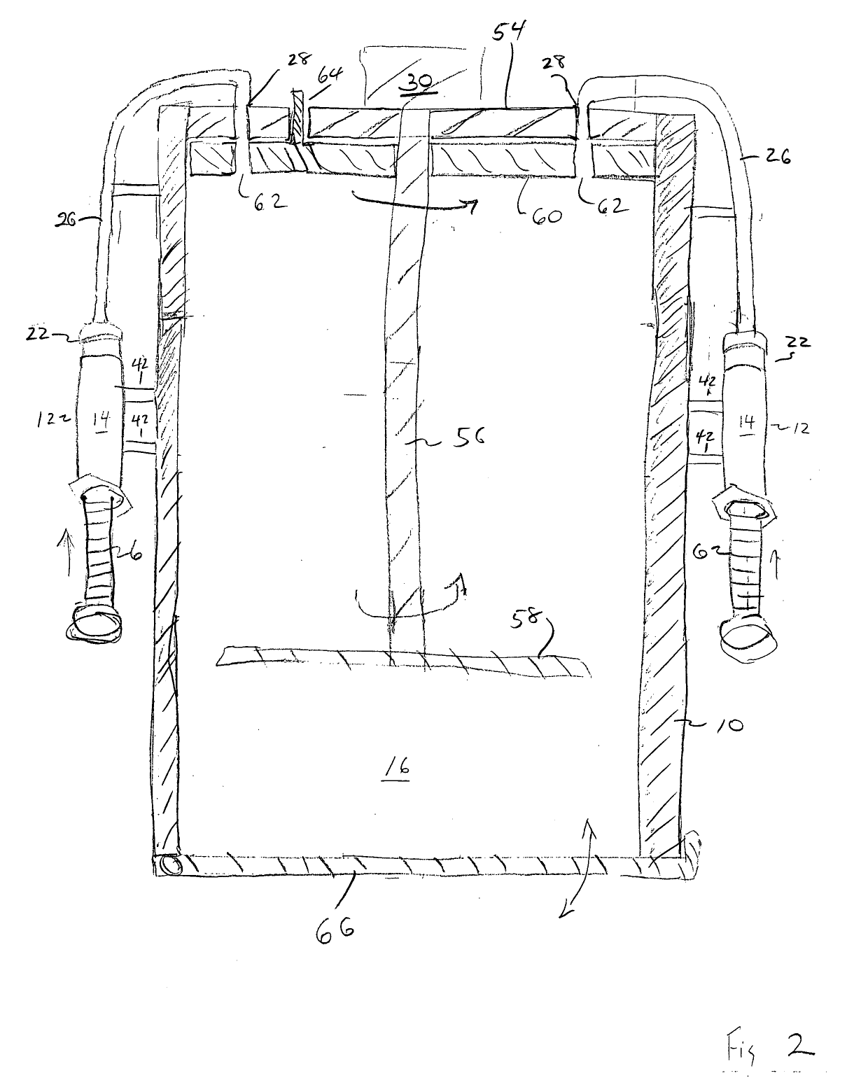

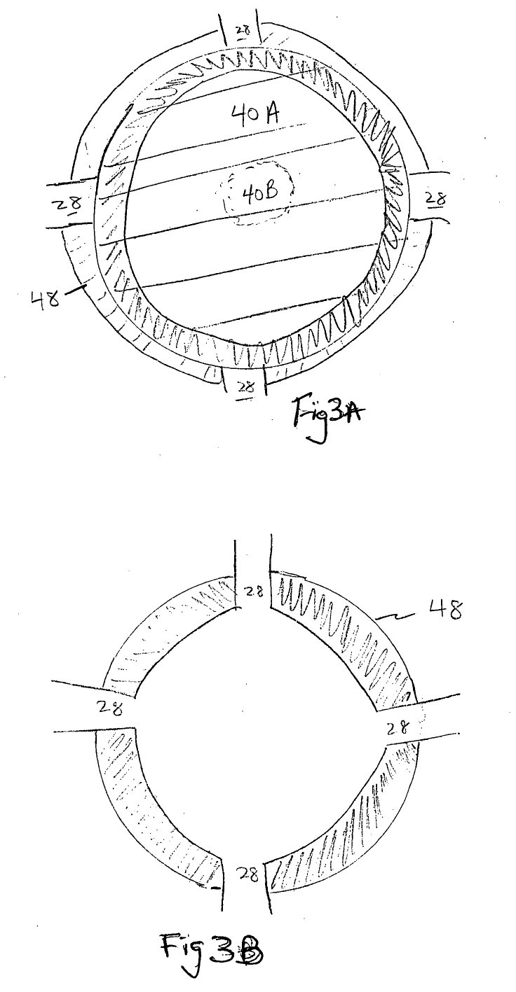

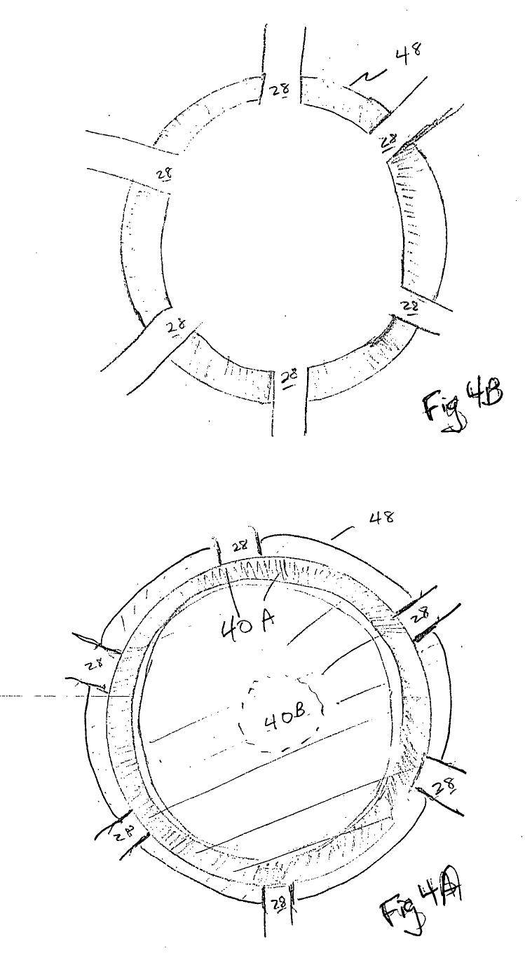

As shown in FIGS. 1 and 2, elongated shell 10 is cylindrical in shape and supply chambers 12 are cylindrical in shape. The number of supply chambers can vary, FIG. 2 illustrates two (2) supply chambers, FIGS. 3A-B illustrate four (4) supply chambers, while FIGS. 4A-4B illustrate six (6) supply chambers. The preferred number of supply chambers will depend upon the intended purpose of the dispenser.

Plunger 20 preferably has numbers from 0 to 10, evenly spaced thereon. By having the numerical designation on the outside, the user can control the amount of each of the cosmetic compositions added to master chamber 16. The pushing of the plunger 20 causes the movable base 8 to move upward and push cosmetic composition 14 through dispensing tip 22, flexible tube 26 and outlet 28 into master chamber 16 when master plunger 40 is in a down position such that outlet 28 opens into master chamber 16. Alternatively, plunger 20 is threaded 6, FIG. 2, to allow for more accurate dosing.

Removing cap top 18 from master chamber 16 opens the top of mixing chamber 16 and allows access to the homogeneous fluid mixture contained in master chamber 16. The user can then employ a finger or other applicator 52 for removing the mixture from the mixing chamber. Walls 48 prevent spillage of the mixed composition. Applicator 52 can be stored in the bottom portion of the elongated shell 10. For example, in the embodiment of FIG. 1, the bottom of the elongated shell 10 can house applicator 52 such as a brush or a paddle which is used to apply the cosmetic to the user.

Movable master plunger 40 slides up and down in elongated shell 10. Shell 10 has two or more holder brackets 42 mounted thereon. When the movable plunger 40 is pushed upwards, outlets 28 are closed as shown in FIG. 1. Movable plunger 40 slides back down in order to open outlet 28, as shown in FIG. 1 phantom version. As shown in FIGS. 3A and 4A, outlets 28 are closed because plunger 40 is up. As shown in FIGS. 3B and 4B, by sliding the movable plunger 40 down, outlets 28 are open and allow fluid composition 14 to flow from supply chambers 12 into master chamber 16. When the movable plunger 40 is positioned, such that outlets 28 are closed as shown in FIG. 3A, no fluid composition 14 can flow between the two chambers.

In FIG. 2, outlet 28 is in top wall 54 of master chamber 16. DC motor 30 is connected by shaft 56 to bar 58. Located on top wall 54 is movable cover 60 which has holes 62 that align with outlets 28 to allow supply fluid 14 to enter master chamber 16. Rotating cover 60 with handle 64 misaligns holes 62 with outlets 28 and closes outlet 28. Hinged cap 68 acts both as a bottom wall for master chamber 16 and an outlet for mixed fluid from master chamber 16. U.S. Pat. No. 6,655,551, the disclosure of which is incorporated herein by reference, teaches a plate which operates in a manner similar to cover 60 to close off the outlets from the individual supply chambers.

For cosmetic compositions, the dispenser is preferably small. A preferred outside diameter of the shell is 3 cm. The preferred diameter of each of the supply chambers is 0.7 cm and a height of approximately 3 cm.

The dispenser of the present invention can be used in a number of areas. The following are a number of examples where the dispenser can be used.

Cosmetics

The dispenser of the present invention can be used for mixing different colored cosmetic compositions to arrive at a desired color. For example, lipstick is sold in a myriad of colors. In accordance with the present invention, two or more, and preferably three, four, five or six, different colored fluid cosmetic compositions are loaded into the individual supply chambers and then metered out to the master chamber based on the final color that the user wants.

The color of the cosmetic compositions are preferably the primary colors, i.e. blue, red, and green, or red, yellow, and blue. This allows the user to form any number of shades or colors of a cosmetic composition. Alternatively, the cosmetic composition can have more uniform colors such as a bright red, a rose, and a deep red, which would allow for more subtle color combinations of the cosmetic composition.

Since each one of the supply chambers has an associated dosage means, the user either chooses based on a color chart or based on their own eye (empirically), the amount of each of the cosmetic composition to add to the master chamber.

Once the proper dosage has been added to the master chamber, a mixing means, which is associated with the master chamber, is employed to form a homogeneous mixture. The individual compositions must be compatible so that when they are mixed, a homogeneous mixture is formed.

The cosmetic compositions are compatible in that they are all of the same type of cosmetic composition, the only difference being the color. Thus, for example, each of the supply chambers can house a different colored lipstick. Because the supply chamber has a dosage means, the appropriate amount of each cosmetic composition is then dosed into the master chamber and, when the mixing means mixes the individual cosmetic compositions, they form a homogeneous colored mixture.

Thus, the present invention produces any desired colored cosmetic by adjusting the amount of the individual cosmetic composition of different colors that is dosed into the master chamber.

In an alternative embodiment, one of the supply chambers can house a cosmetic enhancer which is also dosed in and added to the master chamber and subsequently mixed in with the other individual cosmetic compositions to form a homogeneous cosmetic mixture. These cosmetic enhancers will depend, to a certain extent, on the type of cosmetic composition that is in the supply chambers. For example, for a nail polish, nail hardener or sparkle is contained in one of the chambers. For facial foundation or lipstick, a moisturizer or sun block can be included as a cosmetic enhancer. Obviously, moisturizer or sun block can be combined into one and included in one of the chambers. Furthermore, a perfume or scented fluid can be included in one of the chambers to add a scent to the final cosmetic composition.

For lipstick, eye shadow, facial foundation, the user can use their finger or an applicator to apply the mix. The user unscrews the dispenser port and uses their finger to apply the mix. For nail polish, a specific applicator is housed in the bottom and is employed to paint the mixture onto the nails.

Personal Hygiene

The dispenser of the present invention can also be used for mixing different personal hygiene compositions to arrive at the desired mixture. In this case, each one of the supply chambers houses a different individual fluid composition that is added to the master chamber so as to form the desired mixture. For example, different suntan lotions having different blocking or prevention factor (conventionally referred to as Sun Protection Factor or SPF) ratings can be used along with a moisturizer or different scented fluids. For toothpaste, one chamber can have a cleaning composition, the second chamber a whitening composition, and the third chamber a flavor such as mint, regular, bubble gum. The shampoo can have the base soap in one chamber, fragrance such as pine, lilac, rose, in the second chamber, and the third chamber houses a conditioner. The embodiment of the present Invention in FIG. 2 is preferred for shampoo. For hand soap, the three chambers can hold scent, base soap, and a hand conditioner. For deodorant, the chambers can house a deodorant base, a fragrance, and a skin softener. For hand lotion, the chambers can contain a base, a skin softener, and a scent. These are just examples of the types of individual compositions that can be employed to form the homogeneous mixture.

It will be understood that the claims are intended to cover all changes and modifications of the preferred embodiments of the invention herein chosen for the purpose of illustration which do not constitute a departure from the spirit and scope of the invention.

What is claimed is:

1. A portable dispenser for mixing individual fluids and forming and dispensing a mixed fluid comprising:
(a) an elongated frame;
(b) a master chamber affixed inside said frame, said master chamber having a mixing means for mixing individual fluids and forming a mixed fluid;
(c) two or more supply chambers affixed outside said frame, each of said supply chambers being in fluid communication with said master chamber, each of said supply chambers having a dosage means for dosing individual fluid from said supply chamber to said master chamber; and
(d) an exit port in a wall of said master chamber to allow mixed fluid to be dispensed from said master chamber.

2. The dispenser of claim 1 wherein said frame is a shell.

3. The dispenser of claim 1 wherein
said mixing means comprises an impeller positioned in said master chamber, a motor positioned outside said master chamber and a shaft connecting said impeller to said motor.

4. The dispenser of claim 1 wherein
said mixing means comprises one or more wires extending into said master chamber and a motor positioned outside said master chamber and connected to said wires.

5. The dispenser of claim 1 wherein
said mixing means is a bar positioned in said master chamber, a motor positioned outside said master chamber, and a shaft connecting said bar to said motor.

6. The dispenser of claim 1 wherein
each of said supply chambers has a tube to provide fluid communication between each of said supply chambers and said master chamber.

7. The dispenser of claim 6 wherein
said tube has an outlet positioned in a side wall of said master chamber.

8. The dispenser of claim 6 wherein
said tube has an outlet positioned in a top wall of said master chamber.

9. The dispenser of claim 1 wherein
said dosage means is a supply plunger.

10. The dispenser of claim 9 wherein
said supply plunger has a shaft that is calibrated with numerical indicia.

11. The dispenser of claim 9 wherein
said supply plunger has a threaded shaft and one end of said supply chamber has a threaded hole that mates with said threaded shaft.

12. The dispenser of claim 1 further comprising
a master plunger movable in said master chamber.

13. The dispenser of claim 12 wherein
each of said supply chamber has a tube to provide fluid communication between each of said supply chambers and said master chamber, said tube has an outlet in a side wall of said master chamber, and said plunger is movable from below said outlet to above said outlet.

14. The dispenser of claim 12 wherein
each of said supply chambers has a tube to provide fluid communication between each of said supply chambers and said master chamber, each tube having an exit port at a different height in a side wall of said master chamber, and said plunger movable below and above each different height.

15. The dispenser of claim 1 wherein
said exit port is in a bottom wall of said master chamber.

16. The dispenser of claim 1 wherein
said exit port is in a top wall of said master chamber.
